(19) United States
(12) Patent Application Publication
(10) Pub. No.: US 2025/0110086 A1
(43) Pub. Date: Apr. 3, 2025

(54) TRANSDUCER ATTACHMENT BODY FOR A PROBE, HAVING AT LEAST ONE TRANSDUCER AND ONE LENS, OF AN ACOUSTIC MICROSCOPE, AN ACOUSTIC MICROSCOPE, AND METHOD OF PERFORMING AN ULTRA-SOUND SCANNING MICROSCOPY

(71) Applicant: PVA TEPLA ANALYTICAL SYSTEMS GMBH, Westhausen (DE)

(72) Inventors: Peter HOFFROGGE, Oberkochen (DE); Markus JOAS, Lauchheim (DE); Mario LOWACK, Neuburg an der Kammel (DE); Silvia SCHUHMACHER, Aalen (DE); Markus MERKEL, Huettingen (DE)

(73) Assignee: PVA TEPLA ANALYTICAL SYSTEMS GMBH, Westhausen (DE)

(21) Appl. No.: 18/980,620

(22) Filed: Dec. 13, 2024

Related U.S. Application Data
(63) Continuation of application No. PCT/EP2023/076775, filed on Sep. 27, 2023.

(30) Foreign Application Priority Data
Oct. 4, 2022 (DE) 10 2022 125 468.2

(51) Int. Cl. G01N 29/24; G01N 29/06; G01N 29/22; G01N 29/265; G01N 29/28

(52) U.S. Cl. CPC G01N 29/24; G01N 29/0681; G01N 29/221; G01N 29/28; G01N 29/265

(57) ABSTRACT

A transducer attachment body for use with a probe having at least one transducer and one lens, of an acoustic microscope. The transducer attachment body including: a receiving space configured to receive the probe; a supply line for supplying a liquid coupling medium fluidically connected with the receiving space; an outlet opening facing a sample to be examined for the discharge of the liquid coupling medium from the receiving space; and a suction chamber having a negative pressure, is provided outside of the receiving space and laterally at the outlet opening of the receiving space, for suction of the coupling medium escaping from the outlet opening.

### CROSS-REFERENCE TO RELATED APPLICATION

The present application is a continuation of PCT/EP2023/076775 filed on Sep. 27, 2023, which claims priority to German Patent Application No. DE 10 2022 125 468.2, filed on Oct. 4, 2022, the entire contents of each of which are incorporated herein by reference.

### BACKGROUND

### Field

The present disclosure relates to a transducer attachment body for a probe, having at least one transducer and one lens, of an acoustic microscope, for example, an ultrasound scanning microscope, as well as to an acoustic microscope, for example, an ultrasound scanning microscope. In addition, the present disclosure relates to a use or arrangement of a transducer attachment body and to a method for operating an acoustic microscope, for example, an ultrasonic scanning microscope.

### Prior Art

Acoustic microscopes, such as, ultrasonic microscopes, which are also referred to as scanning acoustic microscopes (SAMs), are employed in order to scan samples by means of ultrasound in a scanning method and to process the reflected sound waves in order to generate images of structures of the sample therefrom.

Hereby, the ultrasonic microscopes possess an ultrasonic head, which is also referred to as a probe or transducer head. Therefore, the ultrasonic head consists of an acoustic lens and a sound converter (transducer) connected thereto.

In the case of examination in the acoustic microscopy, water is used as the coupling medium between the acoustic transducer and the sample to be examined in order to obtain a good transmission of the sound waves emitted by the transducer to the sample. For this purpose, a coupling medium with good properties for sound conduction is required.

In ultrasonic microscopy, which operates in the frequency range of 1MHz to 5 GHz, it is typical for the samples to be submerged in a water basin and to be placed on a sample holder, the examination of the sample being conducted in immersion by means of an ultrasonic microscope. In another method, a water jet is used that is formed between the sound converter and the sample in order to ensure a good sound coupling into the sample.

### SUMMARY

An object is to allow in acoustic microscopy that a sample to be examined is brought into contact with a coupling medium only locally and as briefly as possible, wherein for example a stable and bubble-free local coupling medium cushion, such as a water cushion, is provided between the sound converter and the sample. A further object is to retrofit existing acoustic scanning microscopes for acoustic microscopy in a simple manner.

Such object can be solved by a transducer attachment body, such as a transducer head attachment body, for a probe, having at least one transducer and one lens, of an acoustic microscope, such as an ultrasound scanning microscope, having a receiving space for receiving the probe, wherein a supply line for supplying a liquid coupling medium, such as water, is fluidically connected with the receiving space, wherein the receiving space has an outlet opening, which can be circular, facing a sample to be examined for the discharge of the liquid coupling medium from the receiving space, wherein a suction chamber, which is or can be applied with negative pressure, is provided outside of the receiving space and laterally at the outlet opening of the receiving space for suction of the coupling medium escaping from the outlet opening.

In the transducer attachment body for a probe in an acoustic microscope, such as an ultrasonic scanning microscope, a local water cushion is provided between the outlet opening of the receiving space and a surface of a sample to be examined, wherein a good coupling of the ultrasound is allowed by the local water cushion with water as coupling medium between the transducer attachment body, such as outside the outlet opening, and the surface of the sample for the transducer. Thereby, the surrounding regions outside the cushion of the coupling medium remain dry, or, are dried again after a scanning. In the case of an operation of an acoustic microscope the samples can be scanned smoothly and contactlessly, for example, at a speed of up to 2 m/s and a maximum acceleration of 50 m/s².

In the transducer attachment body for a probe in an acoustic microscope, an inner region can be formed by the transducer attachment body by the escape of the coupling medium from the outlet opening of the receiving space, in which inner region a local cushion of a coupling medium can be formed between the receiving space and the surface of the sample, wherein the excess coupling medium can be vacuumed from the surface of the sample in an outer region through the suction chamber by the use of a negative pressure.

In the case of using the transducer attachment body in an acoustic microscope, the examination of water-sensitive samples can be facilitated, since only part of the surface of the sample is occasionally, i.e. temporarily and locally wetted with a coupling medium, while the other regions of the sample surface not examined are not wetted and are dry. Due to the short contact time of the coupling medium provided by the transducer attachment body with the sample surface, oxidation of metallic sample surfaces, for example, can be prevented. Water of pure quality can be used as coupling medium.

Moreover, the acoustic microscope formed with the transducer attachment body can be operated independently of position. This means that the sample can be oriented both horizontally and vertically, and a horizontally oriented sample can be examined on both the lower side and the upper side.

Due to the formation of the receiving space and the outlet opening facing a sample to be examined, the coupling medium can be introduced between the transducer attachment body and the sample, so that a coupling medium between the transducer of the probe and the region of the sample to be examined is formed as a kind of cushion and for example, outside of the receiving space and/or outside of the outlet opening. Due to the use and formation of the suction chamber arranged laterally at the outlet opening of the receiving space, the existing coupling medium outside of the ultrasonic zone can be removed again by suction, thereby the contact time between the coupling medium and the surface of the sample to be examined can be kept short.

Moreover, probes for existing acoustic microscopes, such as ultrasonic scanning microscopes, can be easily retrofittable by the transducer attachment body in order to improve the implementation of existing acoustic microscopes.

By the formation of the suction chamber on the transducer attachment body, which, can be is formed as transducer head attachment body or as probe attachment body, the coupling medium between the transducer attachment body, such as outside the examination zone of the transducer, can be vacuumed.

In the case of arranging a probe in the receiving space, the outlet opening of the receiving space can be formed opposite of the acoustic lens of the probe or opposite of the distal end of the probe. Thus, the outlet opening can be formed centrally or centrically on the outlet side of the receiving space. The outlet opening can be formed on the lower side or on the upper side of the receiving space. In addition, the area of the outlet opening, which can be circular, can be smaller than the cross section of the receiving space, wherein the outlet opening is formed as a flow restriction in the case of the coupling medium escaping from the receiving space.

Further, the suction chamber can surround the outlet opening of the receiving space at least partially annularly or annularly, such as in the region of the outlet side of the receiving space. By this, a larger outer region of a coupling medium cushion can be removed from the sample surface between the receiving space of the transducer attachment body, and the outlet opening and a surface of a sample to be examined by the partially annular or annular suction chamber can be practiced in an effective way.

Due to the transducer attachment body it is possible to continuously supply a flow of the coupling medium from the receiving space of the transducer attachment body to the surface of a sample to be examined and to continuously remove the coupling medium outside of the examination zone of the transducer. An air bubble-free or gas bubble-free cushion can be provided under a lens of the acoustic transducer.

Furthermore, the suction chamber can be fluidically connected with at least one discharge line for discharging the coupling medium from the suction chamber. Through the discharge line a negative pressure can be provided at the suction chamber in order to remove the coupling medium escaped from the outlet opening from the examination zone.

Two or more discharge lines can be fluidically connected with the suction chamber, the two or more discharge lines can be fluidically connected with a global discharge line. Thereby, the discharge lines connected to the suction chamber can open into a global supply line in order to guide the vacuumed coupling medium away from the probe through the global discharge line.

Two discharge lines can be provided for the suction chamber, wherein the suction chamber can comprise two suction chamber openings, wherein each suction chamber opening can be connected to a respective discharge line, wherein for example, the suction chamber openings can be arranged opposite to each other. Due to the provision of the two discharge lines at the suction chamber, the coupling medium can be guided away from the probe in an efficient way at several locations simultaneously.

The inside of the receiving space can be formed as a gas bubble collection region, for example, an air bubble collection region, for gas bubbles, such as air bubbles, contained in the coupling medium. Hereby, the quality of the examinations by the acoustic microscope can be improved, since the gas bubbles do not pass into a zone between the transducer and the surface of the sample to be examined due to the gas bubble collection region and thus do not influence the examinations. Air bubbles or gas bubbles can be caught and collected within the receiving area by the gas bubble collection region, whereby the gas bubbles are not conveyed through the outlet opening of the receiving area.

The gas bubble collection region can comprise a collection channel, wherein for example, the collection channel can be formed to be at least partially circumferential and/or at least partially annular or annular in the inside of the receiving space.

The gas bubble collection region or the collection channel can be formed on the opposite side of the outlet opening of the receiving region.

In addition, the gas bubble collection region or the collection channel can be fluidically connected with the discharge line, such as with a global discharge line, by a bypass line. Hereby, it possible that the micro bubbles collected in the gas bubble collection region or in the collection channel can be removed from the receiving region, for example, continuously.

Further, the receiving space can comprise an introduction opening for introducing a probe into the receiving space, the introduction opening being formed opposite of the outlet opening. Hereby, it is possible to arrange the probe and the transducer within the receiving space of the transducer attachment body. Thereby, it is possible to realize different working distances of the transducer to the sample. For example, the transducer attachment body can be displaced along a lateral surface of the probe and positioned accordingly. Thereby, it is possible that the attachment body can be fixed to the probe accordingly.

Furthermore, the introduction opening can be formed with a sealing body, such as, a sealing ring, and/or that the introduction opening can comprise a recess, which can be circumferential, for a sealing body, such as a sealing ring, wherein the sealing body, such as a sealing ring, can be arranged in the recess.

Furthermore, in case of the transducer attachment body, a rib structure or at least a channel or a channel structure can be formed in the inside of the receiving space on the inner wall of the receiving space. With the arrangement of a probe in the receiving space, it is possible that the flowing coupling medium can be guided from the supply line via the receiving space to the outlet opening of the receiving space through the rib structure or the at least one channel or through the channel structure, which can be formed between the inner wall of the receiving space and the lateral surface of the probe, which can be cylindrical.

The transducer attachment body can be formed as an adapter.

Further, the transducer attachment body can be made of plastic. Thereby, a plastic can be used that releases no or only a few foreign atoms into the coupling medium. For example, plastic materials can be employed that are also suitable for 3D printing. In addition, a dimensionally stable plastic and/or a long- term resistant plastic can be employed as well.

The transducer attachment body can be formed with a readable identification device, which can be wirelessly, such as an RFID chip or a barcode or an EEPROM. By doing so, it is possible to detect a clearly detectable, such as automatically, evaluable feature for the transducer attachment body by a corresponding detection device, whereby the handling of the transducer attachment body can be improved.

Furthermore, the supply line for the coupling medium can comprise a connector linking body for a line, and in that a discharge line or the global discharge line for the coupling medium can comprise a connector linking body for a line, wherein the connector linking body of the supply line and the connector linking body of the discharge line or the global discharge line can be formed differently. For example, the connector linking bodies of the supply line and of the discharge line or of the global discharge line can comprise different geometries, whereby the lines connected to the respective connector linking bodies can be distinctively connected with the respective connector linking bodies.

Further, the object is solved by an acoustic microscope, such as an ultrasonic scanning microscope, with a probe having at least one transducer and one lens, wherein a transducer attachment body, as described above, is arranged on the probe. To avoid repetition, explicit reference is made to the previous explanations.

The supply line can be connected with a coupling medium reservoir for the liquid coupling medium, wherein, for example, a pump connected to the coupling medium reservoir can be provided in the supply line, and/or that the discharge line, such as the global discharge line, can be connected with a negative pressure source.

Moreover, the probe can comprise, such as exclusively, one transducer and one lens, or in that the probe can comprise several transducers and several lenses for each transducer. The probe, which can be introduced into and arranged in the receiving space of the transducer attachment body, can comprise a single transducer with a (single) lens for focusing the (ultra) sound waves. In an alternative configuration, the probe can be formed with, for example, an array, or with an arrangement of several transducers and lenses for the respective transducers. For example, in the case of the array, the transducers can be arranged next to each other in a linear order. Other arrangements of transducers and the lenses are also possible and feasible in this case for the probe.

In addition, the object is solved by a use or an arrangement of a transducer attachment body on a probe of an acoustic microscope, such as an ultrasonic scanning microscope, such as described above, wherein the transducer attachment body can be formed as described above. For this purpose, explicit reference is made to the previous explanations.

Furthermore, the object is solved by a method for operating an acoustic microscope, such as an ultrasonic scanning microscope, wherein the acoustic microscope can be formed with a probe having at least one transducer and one lens, and with a transducer attachment body as described above. To avoid repetition, explicit reference is made to the above explanations.

Further features will become apparent from the description of the embodiments together with the claims and the attached drawings. Embodiments may fulfill individual features or a combination of several features.

The embodiments are described below without restricting the general inventive idea on the basis of exemplary embodiments with reference to the drawings, and regarding any details which are not explained further in the text reference is expressly made to the drawings. In the drawings:

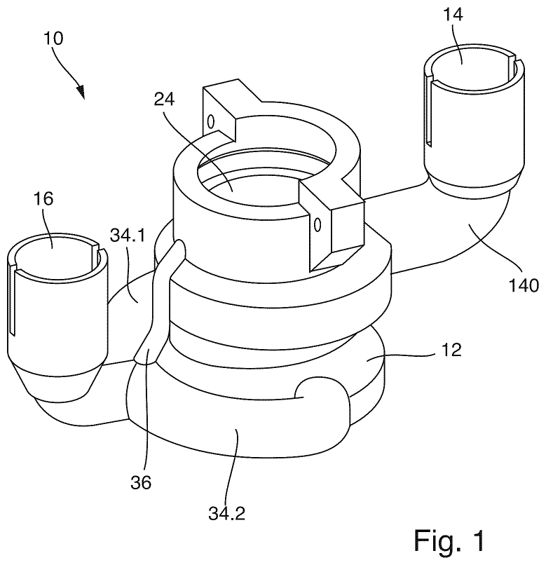

FIG. 1 schematically illustrates a perspective view of a transducer attachment body for a probe of an acoustic microscope,

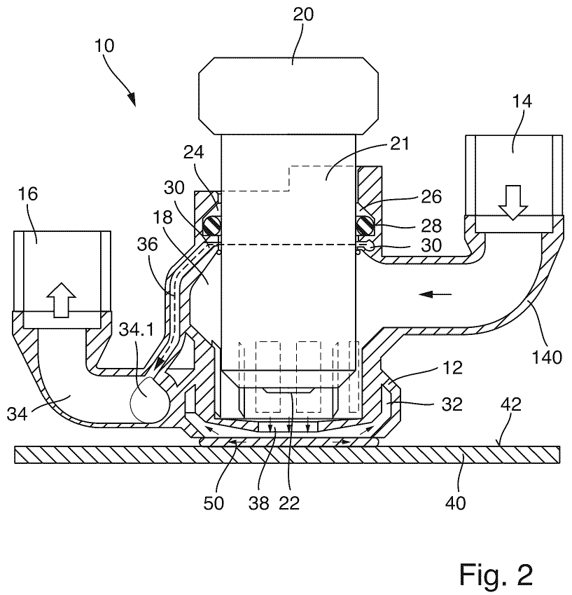

FIG. 2 illustrates a cross section through the transducer attachment body with a probe of an acoustic microscope arranged therein,

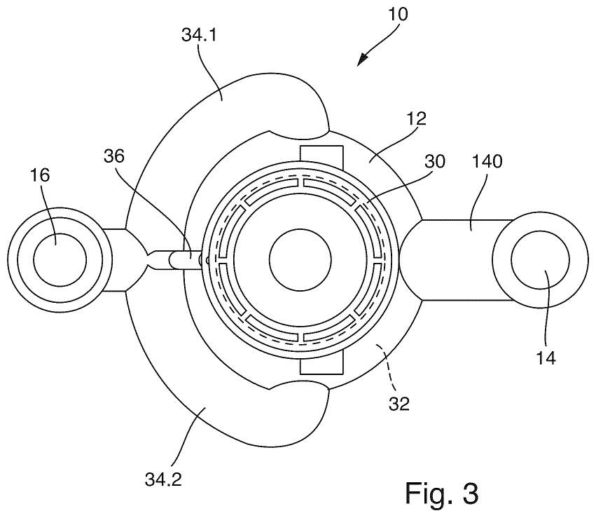

FIG. 3 schematically illustrates a top view of the transducer attachment body, and

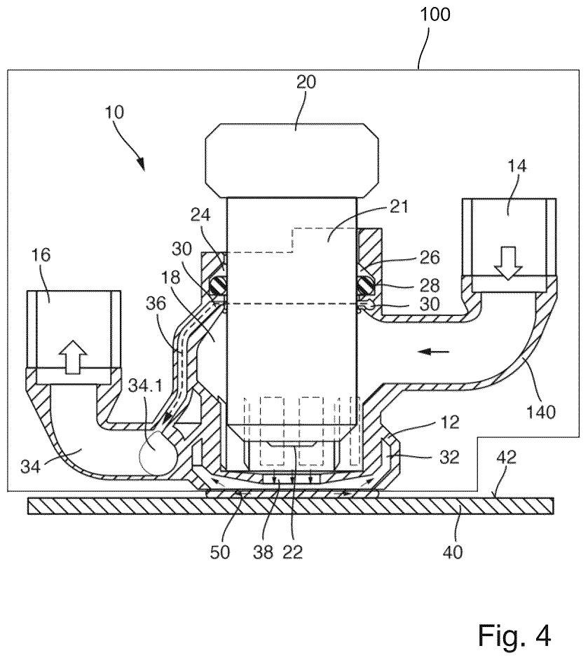

FIG. 4 illustrates an acoustic microscope having a transducer attachment body.

In the drawings, the same or similar types of elements and/or parts are provided with the same reference numbers so that a corresponding re-introduction is omitted.

### DETAILED DESCRIPTION

FIG. 1 is a schematic presentation of a transducer attachment body 10. FIGS. 2 and 3 show a cross section through the transducer attachment body 10 and a plan view of the transducer attachment body 10. The transducer attachment body 10 is made of plastic, such as in a single unitary piece.

The transducer attachment body 10 comprises a main body 12 with a receiving space 18 in the inside. The receiving space 18 is fluidically connected to a supply unit 140 comprising a supply line 14 for supplying a coupling medium, such as water, into the receiving space 18 of the main body 12. Further, the body comprises a discharge unit 16 in order to discharge the coupling medium from a suction chamber 32 of the body 12 (see FIG. 2).

Further details of the transducer attachment body 10 are to be taken from the cross-sectional view of FIG. 2. In the inside, the main body 12 comprises a receiving space 18, which is fluidically connected with the supply unit 140. The supply line 14 of the supply unit 140 itself is provided with a coupling medium reservoir (not represented here) in order to supply a liquid coupling medium, such as water, into the receiving space 18.

In the cross-sectional representation in FIG. 2, a probe 20 of an acoustic microscope, such as an ultrasonic scanning microscope, is introduced into the receiving space 18 through an introduction opening 24 of the main body 12. The probe 20 comprises a sound converter, such as, a transducer 21 for the generation of sound waves, wherein a lens 22 for focusing the sound waves is disposed at the front end of the probe 20. The probe 20 with the transducer 21 and the lens 22 is part of an acoustic scanning microscope (not represented here), such as an ultrasonic scanning microscope.

In the upper region of the introduction opening 24, a circumferential recess 26 is formed, in which a sealing ring 28 is accommodated in order to seal the receiving space 18 with respect to the lateral surface of the probe 20 in case of arrangement of the probe 20 in the receiving space 18.

Upon influx of the coupling medium into the receiving space 18 via the supply unit 140, the coupling medium is guided through channels formed between the outer lateral surface of the probe and the inner wall of the receiving space in the direction of an outlet opening 38, such as on the underside and/or inner circumferential surface of the receiving space 18, so that the coupling medium, such as water, is guided through the outlet opening 38 in the direction of a surface 42 of a sample 40 to be examined.

Due to the spacing of the transducer attachment body 10 to the sample 40 to be examined, a coupling medium cushion 50 is formed between the outlet opening 38 and the surface 42 of the sample 40, so that in operation of the transducer 21 the sound waves will be well coupled to the sample 40 to be examined.

The outlet opening 38 is laterally surrounded by a suction chamber 32, so that the outer region of the coupling medium cushion 50 is removed from the examination zone between the transducer 21 and the surface 42 of the sample 40 by applying a negative pressure to the suction chamber 32. For this purpose, the suction chamber 32 is fluidically connected with two discharge lines 34.1, 34.2 through two opposite orifices (see FIG. 3), which join to a global discharge line 34, wherein upon applying a negative pressure to the global discharge line 34, the discharge lines 34.1, 34.2 fluidically connected therewith continue to being fluidically connected with the suction chamber 32. The suction chamber 32 as well as the discharge lines 34.1, 34.2 and the global discharge line 34 are part of the discharge unit 16 for discharging the coupling medium sucked in or vacuumed.

Further, the receiving space 18 comprises a collecting channel 30 in the region of the sealing ring 28 within the receiving space 18, in order to collect, for example, air bubbles, which are contained in the coupling medium as micro bubbles. The collection channel 38 is further fluidically connected with the global discharge line 34 through a bypass line 36, so that upon applying of negative pressure in the global discharge line 34 the air bubbles or gas bubbles are removed from the collection channel 30 through the bypass line 36.

FIG. 4 illustrates an acoustic microscope 100 having a transducer attachment body 10, which is explained in further detail in FIG. 2.

While there has been shown and described what is considered to be preferred embodiments, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

10 transducer attachment body
12 main corpus
14 supply unit
16 discharge unit
18 receiving space
20 probe
21 transducer
22 lens
24 introduction opening
26 recess
28 sealing ring
30 collection channel
32 suction chamber
34 global discharge line
34.1, 34.2 discharge line
36 bypass line
38 outlet opening
40 sample
42 surface
50 coupling medium cushion
100 acoustic microscope
140 supply unit

1. A transducer attachment body for use with a probe having at least one transducer and one lens, of an acoustic microscope, the transducer attachment body comprising:
a receiving space configured to receive the probe;
a supply line for supplying a liquid coupling medium fluidically connected with the receiving space;
an outlet opening facing a sample to be examined for the discharge of the liquid coupling medium from the receiving space; and
a suction chamber having a negative pressure, is provided outside of the receiving space and laterally at the outlet opening of the receiving space, for suction of the coupling medium escaping from the outlet opening.

2. The transducer attachment body according to claim 1, wherein the suction chamber surrounds the outlet opening at least partially annularly.

3. The transducer attachment body according to claim 2, wherein the suction chamber surrounds the outlet opening at least partially annularly in a region of the outlet side of the receiving space.

4. The transducer attachment body according to claim 1, further comprising at least one discharge line for discharging the coupling medium from the suction chamber, wherein the suction chamber is fluidically connected with the at least one discharge line.

5. The transducer attachment body according to claim 4, further comprising a global discharge line, wherein the at least one discharge line comprises two or more discharge lines, each fluidically connected with the suction chamber, and the two or more discharge lines are fluidically connected with the global discharge line.

6. The transducer attachment body according to claim 5, wherein the suction chamber comprises two suction chamber openings, wherein each suction chamber opening is connected with a respective discharge line of the two or more discharge lines.

7. The transducer attachment body according to claim 6, wherein the two suction chamber openings are arranged opposite to each other.

8. The transducer attachment body according to claim 1, further comprising a gas bubble collection region formed on an inside of the receiving space for gas bubbles contained in the coupling medium.

9. The transducer attachment body according to claim 8, wherein the gas bubble collection region comprises a collection channel.

10. The transducer attachment body according to claim 9, wherein the collection channel is formed at least partially circumferential in the inside of the receiving space.

11. The transducer attachment body according to claim 9, wherein the collection channel is formed at least partially annularly in the inside of the receiving space.

12. The transducer attachment body according to claim 8, wherein the gas bubble collection region is formed on an opposite side of the outlet opening of the receiving region.

13. The transducer attachment body according to claim 9, wherein the collection channel is formed on an opposite side of the outlet opening of the receiving region.

14. The transducer attachment body according to claim 8, wherein the gas bubble collection region is fluidically connected with one of a discharge line or a global discharge line by a bypass line.

15. The transducer attachment body according to claim 9, wherein the collection channel is fluidically connected with one of a discharge line or a global discharge line by a bypass line.

16. The transducer attachment body according to claim 1, wherein the receiving space comprises an introduction opening for introducing a probe into the receiving space, the introduction opening being formed opposite to the outlet opening.

17. The transducer attachment body according to claim 16, wherein the introduction opening is formed with a sealing body disposed within a circumferential recess for holding the sealing body.

18. The transducer attachment body according to claim 16, wherein the sealing body comprises a sealing ring arranged in the recess.

19. The transducer attachment body according to claim 1, wherein a channel is formed in the inside of the receiving space on an inner wall of the receiving space.

20. The transducer attachment body according to claim 1, wherein the transducer attachment body is formed as an adapter.

21. The transducer attachment body according to claim 1, wherein the transducer attachment body is made of plastic.

22. The transducer attachment body according to claim 1, wherein the transducer attachment body is formed with a readable identification device.

23. The transducer attachment body according to claim 1, wherein the readable identification device comprises one of an RFID chip, a barcode or an EEPROM.

24. The transducer attachment body according to claim 1, wherein the supply line for the coupling medium comprises a connector linking body for a line, and in that a discharge line for the coupling medium comprises a connector linking body for a line, wherein the connector linking body of the supply line and the connector linking body of the discharge line are formed differently.

25. An acoustic microscope comprising:
the transducer attachment body according to claim 1, and
a probe with at least one transducer and one lens arranged in the transducer attachment body.

26. The acoustic microscope according to claim 25, wherein the supply line is connected with a coupling medium reservoir for the liquid coupling medium, and wherein a pump, which is connected to the coupling medium reservoir, is provided in one or more of the supply line, and the discharge line is connected to a negative pressure source.

27. The acoustic microscope according to claim 25, wherein the probe comprises one of one transducer and one lens, or several transducers and several lenses for each transducer.

28. A method for performing an acoustic microscopy, the method comprising:
introducing a probe having at least one transducer and one lens into a receiving space of a transducer attachment body configured to receive the probe;
supplying a liquid coupling medium to the receiving space through an inlet of the transducer attachment body; and
creating a negative pressure between the inlet and an outlet to generate a coupling medium cushion between a surface of a sample being observed and the transducer attachment body.
